(19) United States
(12) Patent Application Publication
(10) Pub. No.: US 2009/0198840 A1
(43) Pub. Date: Aug. 6, 2009

(54) Typing Tutoring System and Method for Indicating Finger Placement on a Keyboard

(76) Inventor: Joseph T. Marshall, Rathwell (CA)

Correspondence Address: ADE & COMPANY INC., 2157 Henderson Highway, WINNIPEG, MB, R2G1P9, CA

(21) Appl. No.: 12/303,274

(22) PCT Filed: Jun. 6, 2007
(86) PCT No.: PCT/CA2007/000987

§ 371 Date: Dec. 3, 2008

Related U.S. Application Data
(60) Provisional application No. 60/811,102, filed on Jun. 6, 2006.

(51) Int. Cl. G06F 3/02

(52) U.S. Cl. 710/15

(57) ABSTRACT

A keyboard used for typing tutoring comprises a plurality of keys, in which each key comprises first and second actuators. The first actuator is arranged to generate a keystroke signal when the key is pressed by a first prescribed amount to record a normal keystroke on a computer with which the keyboard is associated. The second actuator is arranged to generate a contact signal when the key is contacted by a user and pressed by a second prescribed amount which is less than the first prescribed amount. An indicator responsive to the contact signals generated by the second actuators of the keys indicates to the user which key has been contacted. The indicator is operable independently of a monitor of the computer which displays the normal keystrokes.

This application claims priority benefits from U.S. provisional application Ser. No. 60/811,102, filed Jun. 6, 2006.

### FIELD OF THE INVENTION

The present invention relates to a typing tutoring system which is associated with a keyboard for indicating finger placement of a user in relation to the keys of the keyboard to assist a user in learning the typing skills on the keyboard.

### BACKGROUND

Use of computers has become common place in many work environments as well as in people's homes, and accordingly keyboarding and typing skills are known to be desirable. Conventional methods of tutoring typing skills however generally rely on conventional keyboards in which a user is unaware of a finger being placed on the wrong key until it is too late and an erroneous keystroke is recorded. It is undesirable therefore to attempt to learn typing skills while trying to perform other useful functions such as running various computer applications because the erroneous keystrokes interfere with the other functions being performed.

U.S. Pat. No. 2,500,507 to Avery et al., U.S. Pat. No. 1,984,599 to Safar, and U.S. Pat. No. 2,931,108 to Brown disclose examples of devices for teaching typing skills, however in each instance the device is unusable for performing typical keyboard operations as the device is dedicated solely to indicating to a user keys have been fully depressed on a keyboard.

U.S. Pat. No. 6,999,009 to Monney and U.S. Pat. No. 3,757,322 to Barkan et al. disclose examples of keyboard configurations however neither is useful for learning typing or keyboarding skills.

### SUMMARY OF THE INVENTION

According to one aspect of the invention there is provided a typing tutoring system for a keyboard comprising a plurality of keys, each comprising an actuator arranged to record a normal keystroke when pressed by a prescribed amount, the system comprising:

a sensor associated with each key and which is arranged to record contact with the key when the key is contacted by a user and pressed by an amount which is less than the prescribed amount; and

an indicator responsive to the sensors which is arranged to indicate to the user which key has been contacted.

The sensors may be arranged to permit a normal keystroke to be recorded when one of the keys is pressed by the prescribed amount comprising either a pressure amount or a displacement amount.

Preferably the indicator continues to indicate contact with a key as long as the key remains contacted.

Preferably the sensor can still be arranged to record contact with the key when the key is contacted but not pressed by a displacement amount.

The indicator preferably comprises a keyboard representation in which the keyboard representation includes a representation of each key of the keyboard and a function associated therewith.

The function being displayed may be varied when a shift key or caps lock key of the keyboard is depressed.

When the system is intended for a keyboard associated with a monitor for displaying normal keystrokes thereon, the indicator preferably comprises a keyboard representation arranged to indicate which key has been contacted by a user and which is independent of the monitor for displaying normal keystrokes thereon.

In further arrangements, the indicator may comprise a keyboard representation displayed on a monitor of a computer which also displays normal keystrokes thereon.

According to a second aspect of the present invention there is provided a keyboard comprising:

a plurality of keys, each key comprising:
a first actuator arranged to generate a keystroke signal when the key is pressed by a first prescribed amount;
a second actuator arranged to generate a contact signal when the key is contacted by a user and pressed by a second prescribed amount which is less than the first prescribed amount; and

an indicator responsive to the contact signals generated by the second actuators of the keys and arranged to indicate to the user which key has been contacted.

Either of the first or second prescribed amounts may comprise a pressure amount or a displacement amount.

According to a further aspect of the present invention there is provided a method of indicating finger placement on a keyboard comprising a plurality of keys, each being arranged to generate a keystroke signal when pressed by a prescribed amount, the method comprising:

providing a sensor associated with each key which is arranged to generate a contact signal responsive to the key being contacted by a user and pressed by an amount which is less than the prescribed amount; and

indicating to the user which key has been contacted responsive to one of the sensors generating a contact signal.

The method may include generating the respective keystroke signal when one of the keys is depressed by the prescribed amount.

The method may further include indicating a key has been contacted responsive to the respective contact signal on a first display which is independent of and separate from a second display arranged for indicating keystrokes responsive to the respective keystroke signals.

By providing sensors which are arranged to record when keys of keyboard are contacted and/or depressed by an amount which is less than the prescribed amount for recording a normal keystroke, finger placement can be indicated to a user before erroneous keystrokes are recorded so that the typing tutoring system can be used to compliment other computer applications being executed at the same time rather than requiring the tutoring system to be a dedicated system as in the prior art. The system according to the present invention is applicable both to keys with letters thereon in a conventional keyboard pattern for typing words, or to keys with numbers thereon in an accounting keypad for example for entering numerical data or performing mathematical calculations and the like. The system as described herein may also be applicable to a musical instrument including a keyboard with various musical notes associated with the individual keys of the keyboard.

Some embodiments of the invention will now be described in conjunction with the accompanying drawings in which:

### BRIEF DESCRIPTION OF THE DRAWINGS

FIG. 1 is a schematic illustration of a keyboard to which the typing tutoring system has been applied for being displayed on the monitor of a conventional computer.

FIG. 2 is a schematic illustration of some of the keys of the keyboard according to the present invention.

FIG. 3 is a schematic illustration of the communication between the keys of the keyboard locating the sensors thereon and the indicator which includes a representation of the keyboard thereon with keys associated with each of the key of the keyboard.

FIGS. 4 through 8 are schematic illustrations of various conditions of the keyboard and the resulting display by the indicator.

FIG. 9 is a schematic illustration of a further embodiment of the typing tutoring system.

FIG. 10 is a schematic representation of one of the keys of the keyboard comprising first and second actuators.

In the drawings like characters of reference indicate corresponding parts in the different figures.

### DETAILED DESCRIPTION

Referring to the accompanying figures there is illustrated a typing tutoring system generally indicated by reference numeral 10. The system 10 is particularly suited for use with a personal computer 12.

The computer 12 typically includes a keyboard 14 having a plurality of individual keys 16 thereon. The keyboard communicates with a processor 18 which records keystrokes of the keys of the keyboard. The processor 18 is arranged to execute various functions related to any number of different software applications depending upon the keystrokes inputted by a user. A monitor 20 is connected to the processor for displaying various information on its display surface 22 including the normal keystrokes of the keys of the keyboard 14 along with the results of various processor functions.

The system 10 generally includes a plurality of sensors 24 which are associated with the keys 16 of the keyboard respectively. A sensor 24 is provided in association with each one of the keys 16 and is arranged for sensing contact of a user's finger with the key to record contact even without any depression of the key at all or with a depression of the key which is less than a prescribed amount which is required in order to record a normal keystroke on the keyboard. Accordingly any contact of the keys which results in a depression which is less than the prescribed amount of depression to record a normal keystroke on the keyboard still results in contact being recorded.

As long as a finger of the user remains in contact with one of the keys, the sensor 24 continues to record contact throughout the key being depressed to record the normal keystroke.

The normal keystroke operation of the keys of the keyboard are not affected by the sensor 24 so that normal keyboard operation is permitted for executing various functions in the different software applications of the processor as desired.

An indicator 26 is provided in the form of a display on the display surface 22 of the monitor 20 of the computer. The contacts recorded by the sensors 24 are thus commonly displayed on the same display surface as the inputted normal keystrokes on the keyboard. The display of the indicator 26 comprises an image displayed on the computer monitor which occupies only a portion of the overall display surface 22 so that other computer applications can be continued to operate normally on the remaining portion of the display surface.

The indicator 26 displays a keyboard representation 28 on the monitor in which each individual key 16 of the keyboard is represented along with the associated function thereof being also displayed. The individual key representations are arranged to be varied in some indicating manner to the user either by colour or variation in notation so that it is clear to the user that contact has been recorded by one of the sensors. Accordingly the individual representations of the keys 16 are changed into an actuated state responsive to the sensor recording a contact and are arranged to remain in the actuated state as long as the sensor continues to record contact with a users finger.

The function associated with each key that is displayed with the key representations is arranged to be varied responsive to any key on the keyboard being depressed which normally would affect the function of the remaining keys. For example when the caps lock key is depressed as in FIG. 7 or the shift key is depressed as in FIG. 8, the function associated with each of the keys that is displayed along with the key representations by the indictor 26 is also varied to display the new function thereof.

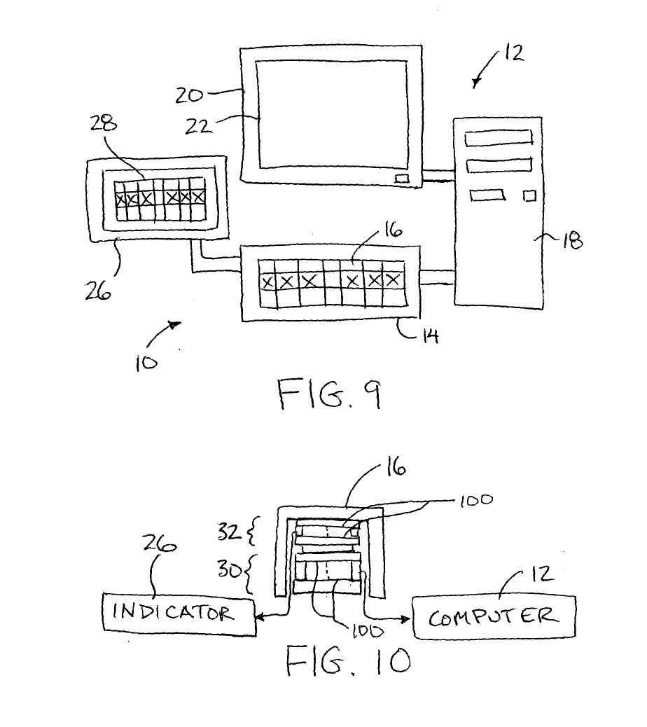

Turning now to FIGS. 4 through 8, the method of operating the system 10 according to the present invention will now be described in further detail. Before placement of the user's fingers on the keys as shown in FIG. 4, the indicator 26 initially indicates that all of the key representations are in an unactuated state. Once the user's fingers are placed on the starting keys prior to typing, as shown in FIG. 5, the appropriate key representations on the keyboard representation 28 displayed on the monitor are accordingly varied into there actuated state to indicate to the user where their fingers are placed, however upon initial contact no normal keystrokes are yet recorded as the keys are not yet depressed in anyway.

As shown in FIG. 6, without depressing the keys in anyway even if a user's finger is simply moved to a different key the different key representation within the key board representation 28 is then transformed into its actuated state while the abandoned key returns to an unactuated state. Therefore before depressing the key, the user can be confident that their finger is on the right key while maintaining their visual focus on the monitor rather than on the keyboard to encourage proper typing technique of not looking at the keyboard.

As shown in FIG. 7, when the caps lock key is depressed on the keyboard the key representations on the keyboard representation are varied to include additional notation which clarifies that the functions of certain keys has been varied. Finger placement is continued to be indicated by the indicator 26 to the use by only keys being contacted being in there respective actuated state. As shown in FIG. 8, a similar variation of the keyboard representation results when the shift key is instead depressed as the new function then associated with each of the keys is noted beside the respective key representations of the keyboard representation 28.

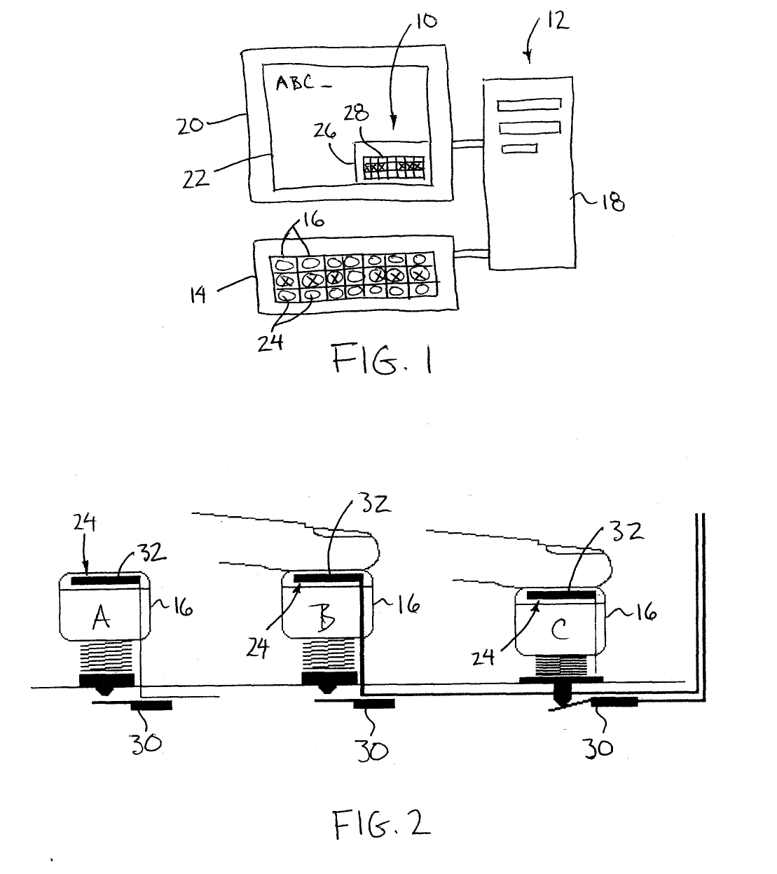

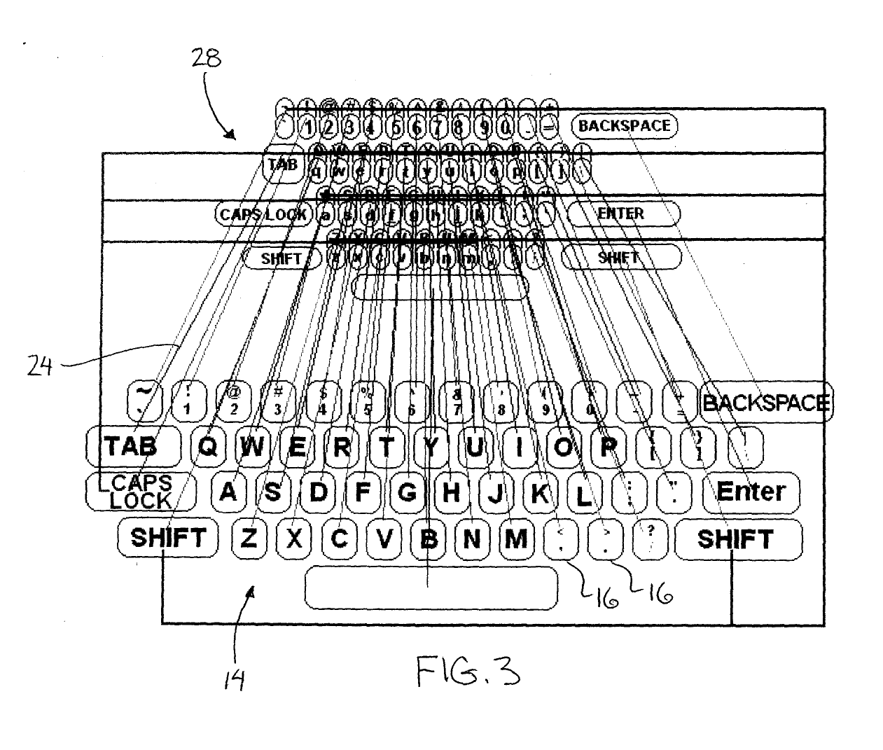

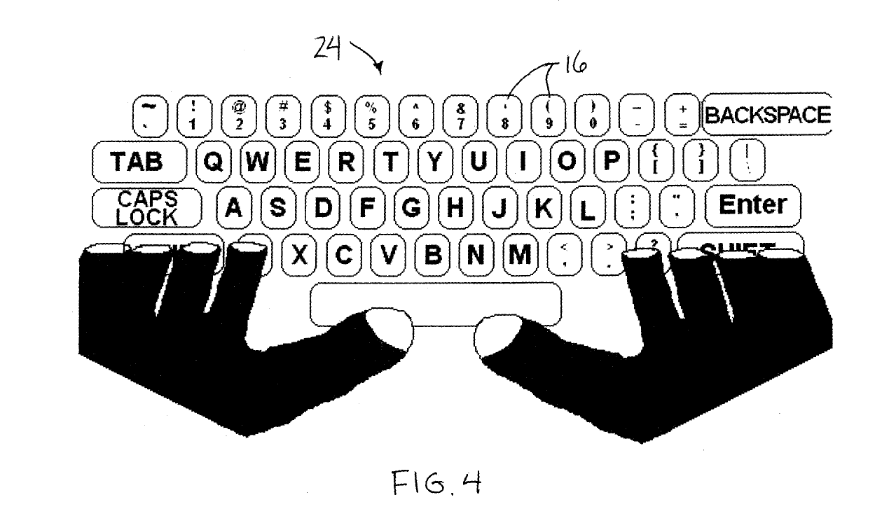

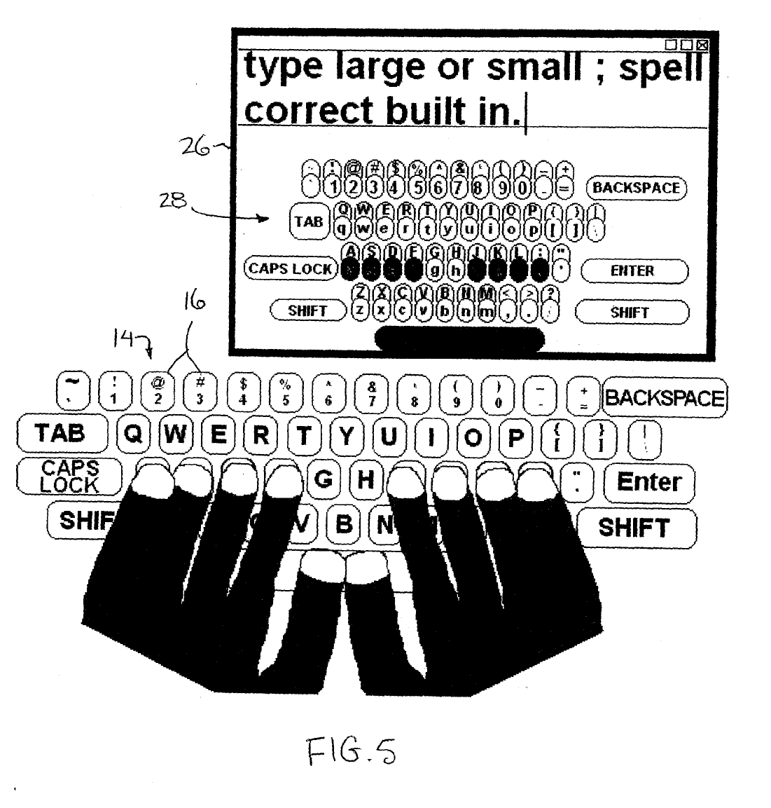

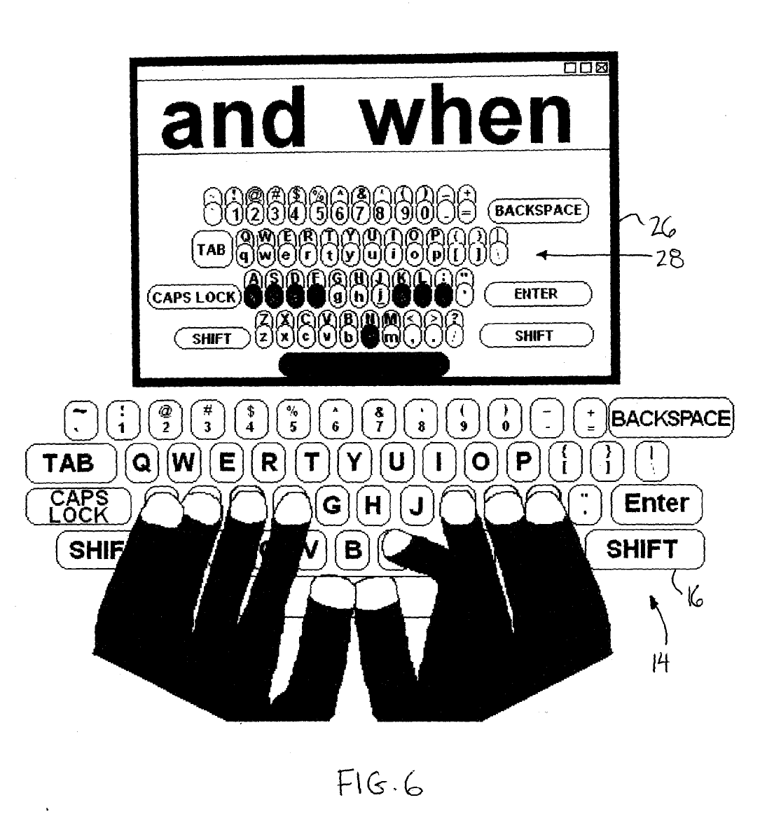

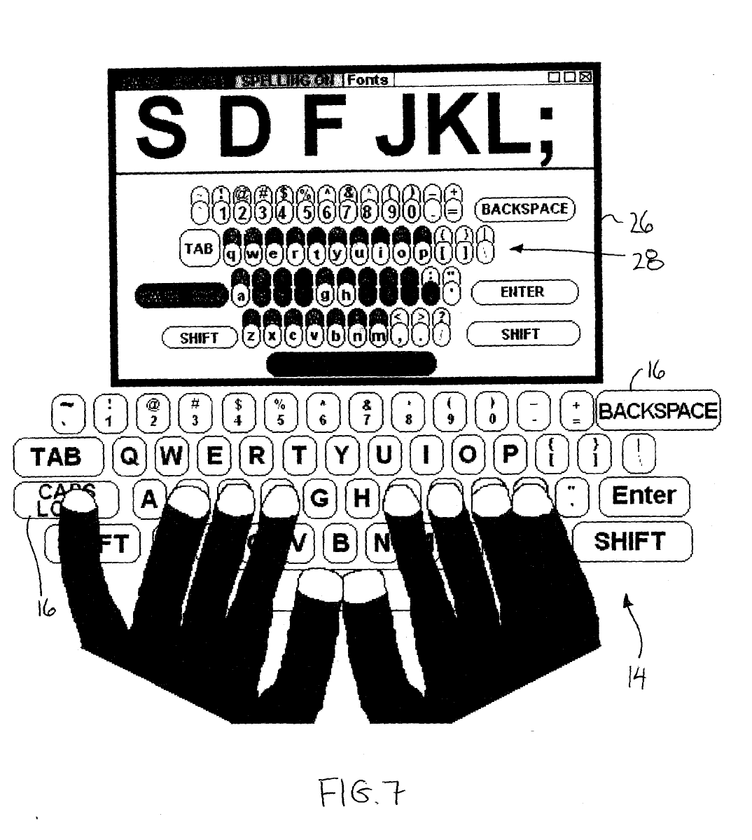

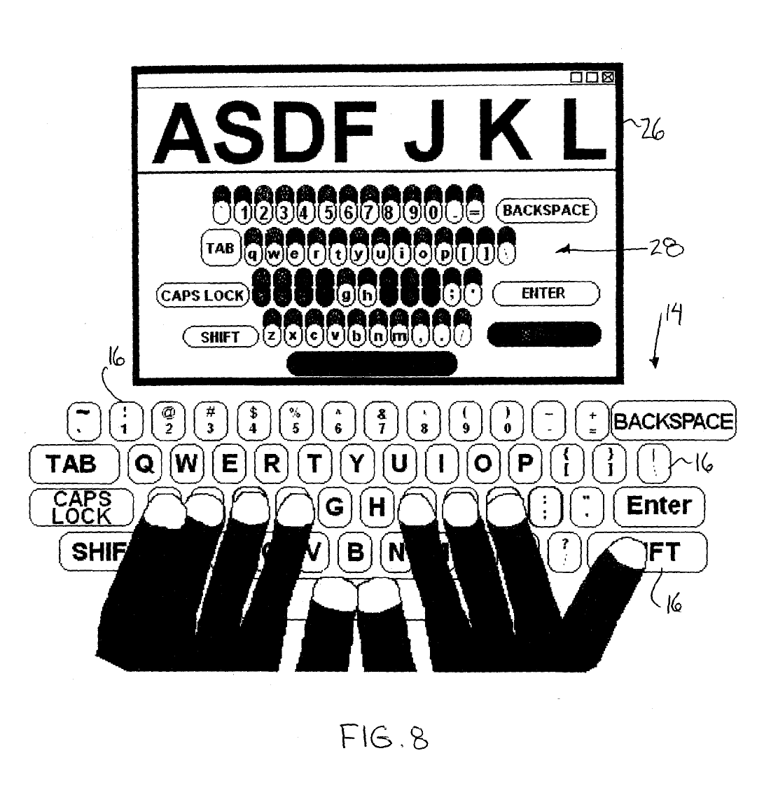

Turning now to FIG. 2 a schematic representation is shown of the resulting key structure when the system is applied to a conventional keyboard. Each key includes a first actuator 30 which is actuated only when the key is depressed by the prescribed amount to record the normal keystroke noted above. Each key also includes a second actuator 32, described above as the sensor 24 which records only contact with the key.

In FIG. 2, the key A is shown with neither the first or second actuators being actuated, however the key B is shown with the second actuator 32 being actuated by contact with a user's finger despite the first actuator 30 not yet being contacted as the key has not been depressed by the prescribed amount. Finally key C is shown depressed by the prescribed amount so that the second actuator 32 continues to be actuated for indicating finger placement while the first actuator 30 is also actuated to record a normal keystroke.

The system in some embodiments may also include a spelling function in which normal keystrokes are displayed in the indicator portion of the display surface along with the keyboard representation. The spelling function checks the spelling of any words typed and automatically corrects the spelling of recognizable words having spelling errors in them so that the normal keystrokes inputted into other functions of the computer are already corrected for spelling.

Referring now to FIGS. 9 and 10, a further embodiment of the system 10 is illustrated which functions in a manner similar to the previous embodiment so that a keyboard 14 is arranged to record normal keystrokes to a computer 12 while also generating contact signals to indicate contact of a user's fingers with the keys of the keyboard on an indicator 26. In the embodiment of FIGS. 9 and 10, the keyboard 14 includes keys having the first actuator 30 and the second actuator 32 integrally formed with each key. The first actuator 30 is arranged to generate a keystroke signal when pressed by a user by a first prescribed amount similarly to the previous embodiment. The second actuator 32 is similar arranged to produce a contact signal when pressed by the user by a second prescribed amount which is either less in displacement or less in pressure in relation to the first prescribed amount of the first actuator. The keyboard 14 is arranged to be connected to the processor 18 of a computer 12 for operation in the usual manner so that the keystroke signals being generated by keystrokes of the first prescribed amount are arranged to be displayed as keystrokes on the display area of the monitor 20.

The indicator 26 in this embodiment comprises a separate display which is independent of the monitor 20 of the computer. The indicator is instead coupled directly to the keyboard 14 independently of the computer for receiving the contact signals directly from the keyboard while the keystroke signals are instead sent from the keyboard to the computer.

When the prescribed amounts comprise displacement amounts, both the first and second actuators according to the illustrated embodiment comprise membrane switches each comprised of a pair of contacts 100 which are held by resilient material to be spaced apart from one another. The contacts of the first actuator 30 are held further apart from one another than the second actuator 32 and require a greater amount of force being pressed by a user on the key 16 in order to bring the contacts together as compared to the contacts of the second actuator. In an exemplary embodiment, a force comparable to a weight of 25 grams or greater being applied to the key 16 is sufficient to actuate the second actuator 32 to produce the contact signal which then indicates contact with a key on the indicator 26. When pressing on the key by a force which is nearer to the equivalent of 150 grams of weight applied to the key, the first prescribed amount is reached and the first actuator is accordingly arranged to generate the keystroke signal which is directed to the processor of the computer for displaying the keystroke on the monitor of the computer in a manner similar to the conventional keyboard connected to a computer.

In some embodiments the prescribed amounts of the first and second actuators respectively may comprise pressure amounts. In this instance the first and second actuators associated with a particular key 16 may comprise a single pressure sensitive switch such that the first and second actuators comprise different pressure thresholds of the common pressure sensitive switch. In this instance the single pressure sensitive switch still comprises a first actuator arranged to generate a keystroke signal when the first pressure threshold is reached while the switch functions also as the second actuator 32 to generate the contact signal when the second prescribed amount is reached by pressing the key with a lesser pressure.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A typing tutoring system for a keyboard comprising a plurality of keys, each comprising an actuator arranged to record a normal keystroke when pressed by a prescribed amount, the system comprising:
a sensor associated with each key and which is arranged to record contact with the key when the key is contacted by a user and pressed by an amount which is less than the prescribed amount; and
an indicator responsive to the sensors which is arranged to indicate to the user which key has been contacted.

2. The system according to claim 1 wherein the sensors are arranged to permit a normal keystroke to be recorded when one of the keys is pressed by the prescribed amount.

3. The system according to claim 1 wherein the prescribed amount comprises a pressure amount.

4. The system according to claim 1 wherein the prescribed amount comprises a displacement amount.

5. The system according to claim 1 wherein the indicator is arranged to continue to indicate contact with a key as long as the key remains contacted.

6. The system according to claim 1 wherein the sensor is arranged to record contact with the key when the key is contacted but not depressed.

7. The system according to claim 1 wherein the indicator comprises a keyboard representation and the keyboard representation includes a representation of each key of the keyboard and a function associated therewith.

8. The system according to claim 7 wherein the representation of the function is arranged to be varied when a shift key of the keyboard is depressed.

9. The system according to claim 7 wherein the representation of the function is arranged to be varied when a caps lock key of the keyboard is depressed.

10. The system according to claim 1 for a keyboard associated with a monitor for displaying normal keystrokes thereon wherein the indicator comprises a keyboard representation arranged to indicate which key has been contacted by a user and which is independent of the monitor for displaying normal keystrokes thereon.

11. The system according to claim 1 wherein the indicator comprises a keyboard representation displayed on a monitor.

12. A keyboard comprising:
a plurality of keys, each key comprising:
a first actuator arranged to generate a keystroke signal when the key is pressed by a first prescribed amount;
a second actuator arranged to generate a contact signal when the key is contacted by a user and pressed by a second prescribed amount which is less than the first prescribed amount; and
an indicator responsive to the contact signals generated by the second actuators of the keys and arranged to indicate to the user which key has been contacted.

13. The keyboard according to claim 12 wherein the first prescribed amount comprises a pressure amount.

14. The keyboard according to claim 12 wherein the first prescribed amount comprises a displacement amount.

15. The keyboard according to claim 12 wherein the second prescribed amount comprises a pressure amount.

16. The keyboard according to claim 12 wherein the second prescribed amount comprises a displacement amount.

17. (canceled)

18. The keyboard according to claim 12 wherein the second actuator is arranged to record contact with the key when the key is contacted but not pressed by a user.

19. The keyboard according to claim 12 wherein the indicator comprises a keyboard representation and the keyboard representation includes a representation of each key of the keyboard and a function associated therewith.

20. The keyboard according to claim 12 for use with a monitor for displaying keystrokes thereon responsive to the keystroke signals and wherein the indicator is independent of the monitor.

21. A method of indicating finger placement on a keyboard comprising a plurality of keys, each being arranged to generate a keystroke signal when pressed by a prescribed amount, the method comprising:
providing a sensor associated with each key which is arranged to generate a contact signal responsive to the key being contacted by a user and pressed by an amount which is less than the prescribed amount; and
indicating to the user which key has been contacted responsive to one of the sensors generating a contact signal.

22. (canceled)

23. (canceled)
